(19) United States
(12) Patent Application Publication
(10) Pub. No.: US 2014/0176503 A1
(43) Pub. Date: Jun. 26, 2014

(54) DISPLAY CONTROL SYSTEM AND METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: Xin GUO, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/965,211

(22) Filed: Aug. 13, 2013

(30) Foreign Application Priority Data
Dec. 21, 2012 (CN) 2012105602713

(51) Int. Cl. G06F 3/03

(52) U.S. Cl. CPC G06F 3/0304
USPC 345/175

(57) ABSTRACT

A display control system and a display control method adapted for a portable touch control device are disclosed. The portable touch control device includes a touch screen. The portable touch control device defines two sensitive areas for sensing ambient light and an operation area which receives touch operations from a user on the touch screen. When a hand holds the portable touch control device, the display control system reduces a size of the current operation area and moves the reduced operation area to a new position near the thumb of the hand, thus, the hand can hold and operate the touch screen synchronously.

### BACKGROUND

1. Technical Field

The disclosure relates to touch control technology and, more particularly, to a display control system and a display control method adapted for a portable touch control device.

2. Description of Related Art

Mobile phones including a big touch screen have become popular. As shown in FIG. 4, the user uses the right hand to hold the mobile phone 2 and the thumb can operate a right part of the operation area 200, and the user must use the left hand to operate a left part and the middle of the operation area 200. However, sometimes the user only operates the mobile phone by a single hand, but the single hand cannot operate some areas away from the thumb on the big screen, and it is inconvenient for the user.

Therefore, what is needed is a display control system to overcome the described shortcoming.

### BRIEF DESCRIPTION OF THE DRAWINGS

FIG. 1 is a block diagram of a portable touch control device including a display control system in accordance with an exemplary embodiment.

FIG. 2 is a block diagram of the display control system of the portable touch control device of FIG. 1.

FIG. 3 is a flowchart of a display control method adapted for the portable touch control device of FIG. 1.

FIG. 4 is a schematic view of an operation area operated by both hands in a related art.

FIG. 5 is a schematic view of an operation area operated by a single hand on the portable touch control device of FIG. 1.

### DETAILED DESCRIPTION

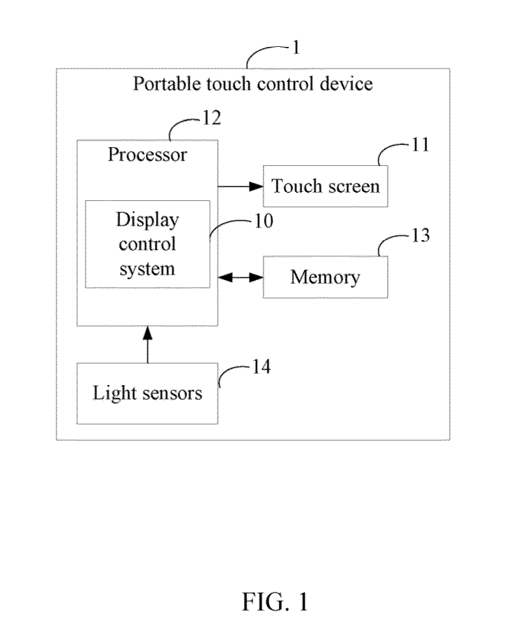

FIG. 1 is a block diagram of a portable touch control device including a display control system in accordance with an exemplary embodiment. The portable touch control device 1 may be a mobile phone including a big touch screen. When a user operates the portable touch control device 1, the portable touch control device 1 is held in one hand, for example, the thumb of the hand grips on one side of the portable touch control device 1 and the fingers grips on an opposite side.

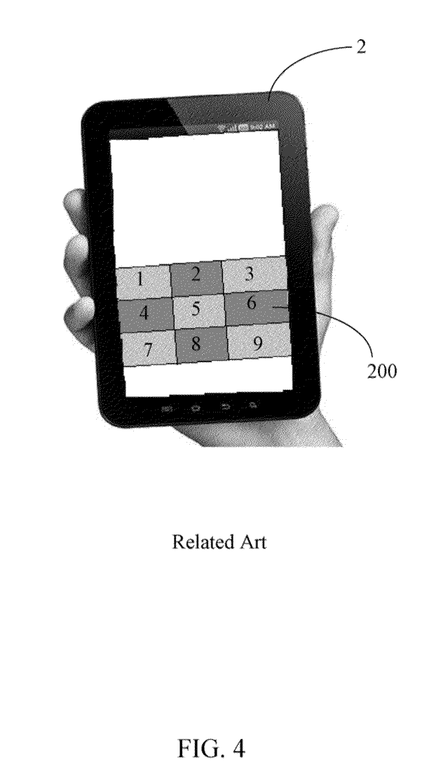

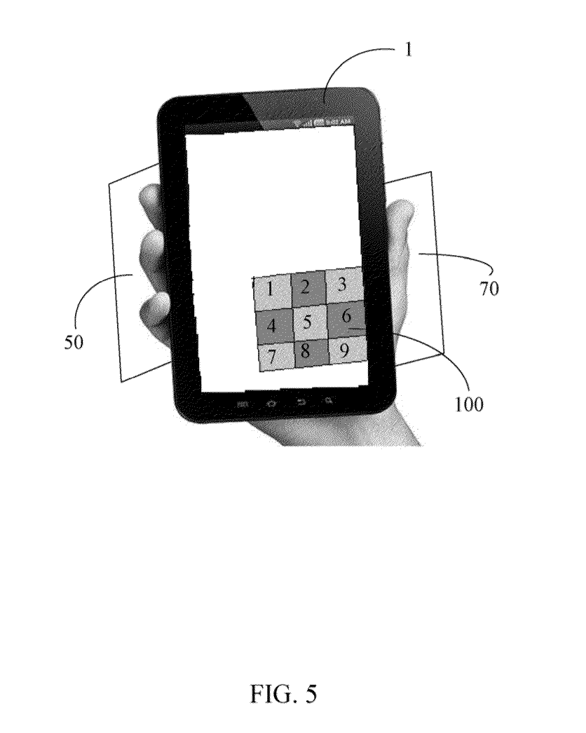

The portable touch control device 1 includes a touch screen 11, a processor 12, a memory 13, and a number of light sensors 14. The touch screen 11 displays information and receives touch operations from the user. The processor 12 controls the portable touch control device 1 to work and perform the display control system 10. When the touch screen 11 receives a touch operation from the user on the touch screen 11, the processor 12 performs a preset function, such as playing a song. The portable touch control device 1 defines an operation area which responds to touch inputs from the user on the touch screen 11, such as a soft keyboard shown in FIGS. 4 and 5. The operation area 100 may include a number of icons, and when the user clicks an icon on the operation area 100, the processor 12 performs a preset function. The memory 13 stores data, such as a size of the touch screen 11 and a reference size according to which the portable touch control device 1 is held and operated in a single hand.

The portable touch control device 1 defines two sensitive areas for sensing ambient light. Each of the two sensitive areas is evenly arranged with a preset number of the light sensors 14 and is located at a position at the side of the portable touch control device 1. For example, a button is set in each of the two sensitive areas and utilized for prompting a position where the user holds the portable touch control device 1. In the embodiment, the two sensitive areas are formed on two opposite sides of the portable touch control device 1. For example, as shown in FIG. 5, a sensitive area 50 is formed on the left side of the portable touch control device 1 and a sensitive area 70 is formed on the right side. When the user holds the two opposite sides of the portable touch control device 1 in one hand, such as the right hand, the sensitive area 70 is shaded by the thumb and detects that ambient light is continuously shaded, and the sensitive area 50 is shaded by the fingers and detects that ambient light is discontinuously shaded.

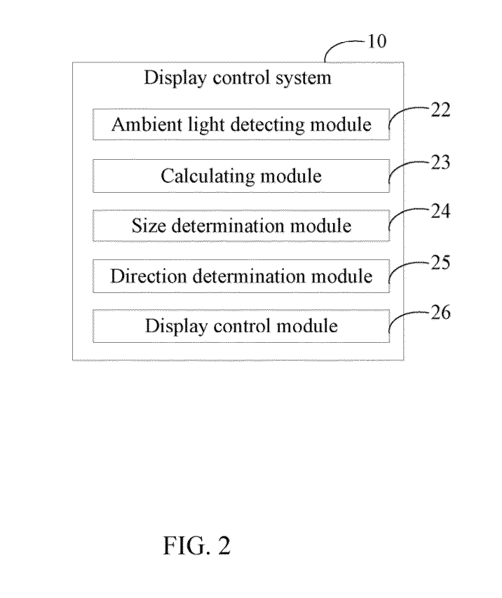

FIG. 2 shows that the display control system 10 further includes an ambient light detecting module 22, a calculating module 23, a size determination module 24, a direction determination module 25, and a display control module 26, all of which are collection of software instructions and executed by the processor 12.

The ambient light detecting module 22 detects ambient light from the two sensitive areas 50, 70 at real time and generates data relative to the ambient light. The calculating module 23 calculates the data relative to the ambient light from the two sensitive areas 50, 70, such as an intensity of the ambient light from the two sensitive areas 50, 70. In another embodiment, the calculating module 23 determines whether or not all light sensors 14 in each of the two sensitive areas 50, 70 do not detect the ambient light.

For example, when the user holds the portable touch control device 1, that is, the sensitive area 70 is shaded by the thumb, and the sensitive area 50 is shaded by the fingers, the calculated intensity of the ambient light from the sensitive area 50 is greater than the calculated intensity of the ambient light from the sensitive area 70, that is, all light sensors 14 in the sensitive area 70 do not detect ambient light and the intensity of the sensitive area 70 is equal to zero, some of all light sensors of the sensitive area 50 detect ambient light and the intensity of the sensitive area 50 is greater than zero, and the shaded size of the ambient light from the sensitive area 70 is greater than the shaded size of the ambient light from the sensitive area 50.

The size determination module 24 acquires a size of the touch screen 11 from the memory 13 and determines whether or not the size of the touch screen 11 meets the need that a user can operate the screen 11 with a single hand. For example, the size determination module 24 compares the size of the touch screen 11 with the reference size stored in the memory 13. When the size of the touch screen 11 is greater than the reference size, the size of the touch screen 11 does not meet the need that a user can operate the screen 11 with a single hand. When the size of the touch screen 11 is less than the reference size, the size of the touch screen 11 meets the need that a user can operate the screen 11 with a single hand.

When the size of the touch screen 11 does not meet the need that a user can operate the screen 11 with a single hand, the direction determination module 25 determines whether a left hand or a right hand holds the portable touch control device 1 according to the data of the ambient light from the two sensitive areas 50, 70. For example, when the calculated intensity of the ambient light from the sensitive area 50 is greater than the calculated intensity of the ambient light from the sensitive area 70, that means that an object shading on the sensitive area 50 is smaller than an object shading on the sensitive area 70, that is, the sensitive area 70 is shaded by the thumb, and the sensitive area 50 is shaded by the fingers, thereupon, the direction determination module 25 determines that the right hand holds the portable touch control device 1.

When the calculated intensity of the ambient light from the sensitive area 70 is greater than the calculated intensity of the ambient light from the sensitive area 50, that means that an object shading on the sensitive area 70 is smaller than an object shading on the sensitive area 50, that is, the sensitive area 50 is shaded by the thumb, and the sensitive area 70 is shaded by the fingers, thereupon, the direction determination module 25 determines that the left hand holds the portable touch control device 1.

When the right hand holds the portable touch control device 1, as shown in FIG. 5, the display control module 26 reduces a size of the current operation area (shown in FIG. 4) based on a preset scale and moves the reduced operation area 100 to a new position near the thumb of the right hand, therefore, the thumb of the right hand can operate the whole reduced operation area 100 and generate touch inputs on the reduced operation area 100, so that it is available to use a single hand to hold and operate the portable touch control device 1.

When the left hand holds the portable touch control device 1, the display control module 26 reduces a size of the current operation area (shown in FIG. 4) based on the preset scale and moves the reduced operation area 100 to a new position near the thumb of the left hand, therefore, the thumb of the left hand can operate the whole reduced operation area 100 and generate touch inputs on the reduced operation area 100, so that it is easy to use a single hand to hold and operate the portable touch control device 1. Furthermore, the display control module 26 performs a function in response to a touch operation on the reduced operation area 100.

Therefore, when the portable touch control device 1 is held in one hand, the display control system 10 reduces a size of the current operation area and moves the reduced operation area 100 to a new position near the thumb of the hand, thus, the hand can hold and operate the touch screen 11 synchronously.

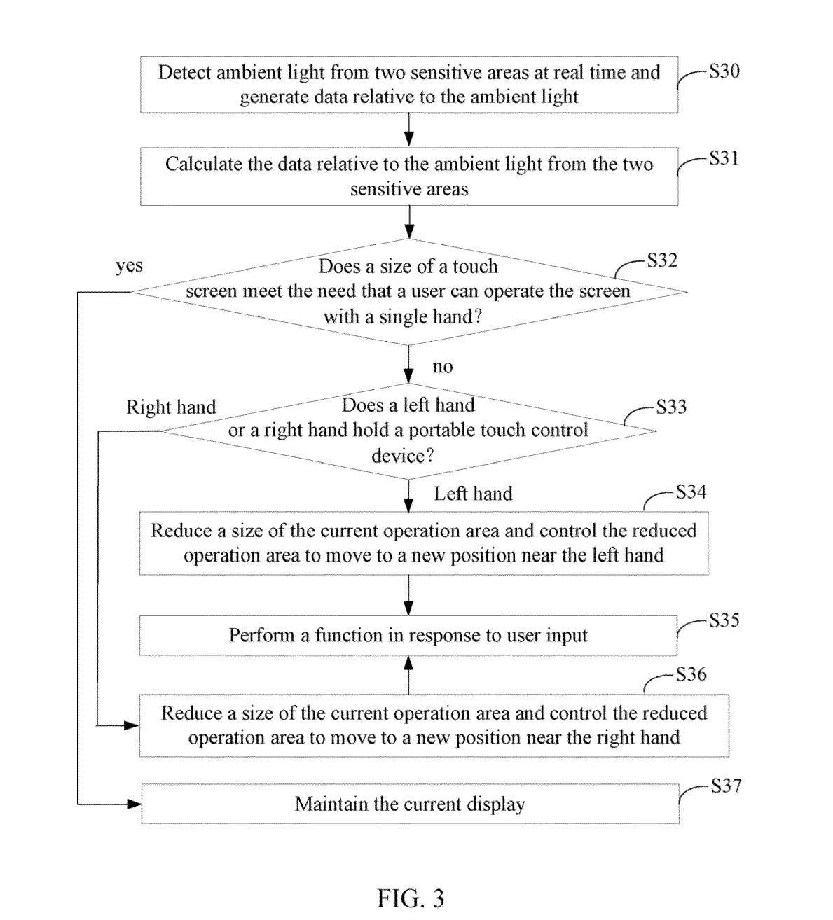

FIG. 3 is a flowchart of a display control method adapted for the portable touch control device of FIG. 1. In step S30, the ambient light detecting module 22 detects ambient light from the two sensitive areas 50, 70 at real time and generates data relative to the ambient light. In step S31, the calculating module 23 calculates the data relative to the ambient light from the two sensitive areas 50, 70.

In step S32, the size determination module 24 acquires a size of the touch screen 11 from the memory 13 and determines whether or not the size of the touch screen 11 meets the need that a user can operate the screen with a single hand 11.

In step S37, when the size of the touch screen 11 meets the need that a user can operate the screen with a single hand 11, the display control module 26 controls the screen 11 to maintain the current display. In step S33, when the size of the touch screen 11 does not meet the need that a user can operate the screen with a single hand 11, the direction determination module 25 determines whether a left hand or a right hand holds the portable touch control device 1 according to the data of the ambient light from the two sensitive areas 50, 70 from the calculating module 23.

In step S34, when the direction determination module 25 determines that the left hand holds the portable touch control device 1, the display control module 26 reduces a size of the current operation area based on a preset scale and controls the reduced operation area 100 to move to a new position near the thumb of the left hand, and the procedure goes to step S35.

In step S36, when the direction determination module 25 determines that the right hand holds the portable touch control device 1, the display control module 26 reduces a size of the current operation area based on a preset scale and controls the and the procedure goes to step S35. In step S35, the display control module 26 performs a function in response to a touch operation on the reduced operation area 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A display control system for a portable touch control device, wherein the portable touch control device comprises a touch screen, the portable touch control device defines two sensitive areas for sensing ambient light and an operation area which receives touch operations from a user on the touch screen, the display control system comprising:
one or more processors; and
a plurality of modules to be executed by the one or more processors, the modules comprising:
an ambient light detecting module to detect ambient light from the two sensitive areas at real time and generate data relative to the ambient light;
a calculating module to calculate the data relative to the ambient light from the two sensitive areas;
a direction determination module to determine whether a left hand or a right hand of a user holds the portable touch control device according to the data relative to the ambient light from the two sensitive areas from the calculating module; and
a display control module to reduce a size of the current operation area and move the reduced operation area to a new position near the thumb of the hand holding the portable touch control device.

2. The display control system of claim 1, wherein the data relative to the ambient light comprises an intensity of the ambient light, when the user holds the portable touch control device with a hand, the calculating module is configured to calculate a first intensity of the ambient light from a first sensitive area and a second intensity of the ambient light from a second sensitive area, when the first intensity of the ambient light from the first sensitive area is greater than the second intensity of the ambient light from the second sensitive area, the direction determination module is configured to determine that a left hand of a user holds the portable touch control device, and when the first intensity of the ambient light from the first sensitive area is less than the second intensity of the ambient light from the second sensitive area, the direction determination module is configured to determine that a right hand of a user holds the portable touch control device.

3. The display control system of claim 1, wherein the portable touch control device stores a size of the touch screen and a reference size, the display control system further comprising:
a size determination module to compare the size of the touch screen with the reference size and determine whether or not the size of the touch screen meets the need that a user can operate the screen with a single hand; and when the size of the touch screen meets the need that a user can operate the screen with a single hand, the display control module is further configured to maintain the current display.

4. The display control system of claim 3, wherein when the size of the touch screen is greater than the reference size, the size of the touch screen does not meet the need that a user can operate the screen with a single hand, and when the size of the touch screen is less than the reference size, the size of the touch screen meets the need that a user can operate the screen with a single hand.

5. The display control system of claim 1, wherein when the right hand holds the portable touch control device, the display control module is configured to reduce the operation area based on a preset scale and move the reduced operation area to a new position near the thumb of the right hand; and when the left hand holds the portable touch control device, the display control module is configured to reduce the operation area based on the preset scale and move the reduced operation area to a new position near the thumb of the left hand.

6. The display control system of claim 1, wherein each of the two sensitive areas is evenly aligned a plurality of light sensors, the calculating module is configured to determine whether or not all light sensors in each of the two sensitive areas do not detect the ambient light, when all light sensors from a first sensitive area do not detect the ambient light, the direction determination module is configured to determine that a left hand of a user holds the portable touch control device, and when all light sensors from a second sensitive area do not detect the ambient light, the direction determination module is configured to determine that a right hand of a user holds the portable touch control device.

7. The display control system of claim 1, wherein the two sensitive areas are formed on two opposite sides of the portable touch control device.

8. A display control method adapted for a portable touch control device, wherein the portable touch control device comprises a touch screen, the portable touch control device defines two sensitive areas for sensing ambient light and an operation area which receives touch operations from a user on the touch screen, the method comprising:
detecting ambient light from the two sensitive areas at real time and generating data relative to the ambient light;
calculating the data relative to the ambient light from the two sensitive areas;
determining whether a left hand or a right hand of a user holds the portable touch control device according to the data relative to the ambient light from the two sensitive areas; and
reducing a size of the current operation area and moving the reduced operation area to a new position near the thumb of the hand holding the portable touch control device.

9. The display control method of claim 8, wherein the data relative to the ambient light comprises an intensity of the ambient light, further comprising:
when the user holds the portable touch control device, calculating a first intensity of the ambient light from a first sensitive area and a second intensity of the ambient light from a second sensitive area;
when the first intensity of the ambient light from the first sensitive area is greater than the second intensity of the ambient light from the second sensitive area, determining that a left hand of a user holds the portable touch control device; and
when the first intensity of the ambient light from the first sensitive area is less than the second intensity of the ambient light from the second sensitive area, determining that a right hand of a user holds the portable touch control device.

10. The display control method of claim 8, wherein the portable touch control device stores a size of the touch screen and a reference size, the method further comprising:
comparing the size of the touch screen with the reference size and determining whether or not the size of the touch screen meets the need that a user can operate the screen with a single hand; and
when the size of the touch screen meets the need that a user can operate the screen with a single hand, maintaining the current display.

11. The display control method of claim 10, wherein when the size of the touch screen is greater than the reference size, the size of the touch screen does not meet the need that a user can operate the screen with a single hand, and when the size of the touch screen is less than the reference size, the size of the touch screen meets the need that a user can use operate the screen with a single hand.

12. The display control method of claim 9, further comprising:
when the right hand holds the portable touch control device, reducing the operation area based on a preset scale and moving the reduced operation area to a new position near the thumb of the right hand; and
when the left hand holds the portable touch control device, reducing the operation area based on the preset scale and moving the reduced operation area to a new position near the thumb of the left hand.

13. The display control method of claim 8, wherein each of the two sensitive areas is evenly aligned a plurality of light sensors, the method further comprising:
determining whether or not all light sensors in each of the two sensitive areas do not detect the ambient light;
when all light sensors from a first sensitive area do not detect the ambient light, determining that a left hand of a user holds the portable touch control device; and
when all light sensors from a second sensitive area do not detect the ambient light, determining that a right hand of a user holds the portable touch control device.

14. A computer-readable storage medium encoded with a computer program, the program comprising instructions that when executed by one or more computers cause the one or more computers to perform operations for controlling a display of a portable touch control device, the operations comprising:
detecting ambient light from two sensitive areas at real time and generating data relative to the ambient light;
calculating the data relative to the ambient light from the two sensitive areas;
determining whether a left hand or a right hand of a user holds the portable touch control device according to the data relative to the ambient light from the two sensitive areas; and
reducing a size of the current operation area and moving the reduced operation area to a new position near the thumb of the hand holding the portable touch control device.

15. The computer-readable storage medium encoded with a computer program of claim 14, wherein the data relative to the ambient light comprises an intensity of the ambient light, the operations further comprising:
when the user holds the portable touch control device, calculating a first intensity of the ambient light from a first sensitive area and a second intensity of the ambient light from a second sensitive area;
when the first intensity of the ambient light from the first sensitive area is greater than the second intensity of the ambient light from the second sensitive area, determining that a left hand of a user holds the portable touch control device; and
when the first intensity of the ambient light from the first sensitive area is less than the second intensity of the ambient light from the second sensitive area, determining that a right hand of a user holds the portable touch control device.

16. The computer-readable storage medium encoded with a computer program of claim 14, wherein the portable touch control device stores a size of the touch screen and a reference size, the operations further comprising:
comparing the size of the touch screen with the reference size and determining whether or not the size of the touch screen meets the need that a user can operate the screen with a single hand; and
when the size of the touch screen meets the need that a user can operate the screen with a single hand, maintaining the current display.

17. The computer-readable storage medium encoded with a computer program of claim 16, wherein when the size of the touch screen is greater than the reference size, the size of the touch screen does not meet the need that a user can operate the screen with a single hand, and when the size of the touch screen is less than the reference size, the size of the touch screen meets the need that a user can operate the screen with a single hand.

18. The computer-readable storage medium encoded with a computer program of claim 14, the operations further comprising:
when the right hand holds the portable touch control device, reducing the operation area based on a preset scale and moving the reduced operation area to a new position near the thumb of the right hand; and
when the left hand holds the portable touch control device, reducing the operation area based on the preset scale and moving the reduced operation area to a new position near the thumb of the left hand.

19. The computer-readable storage medium encoded with a computer program of claim 14, wherein each of the two sensitive areas is evenly aligned a plurality of light sensors, the operations further comprising:
determining whether or not all light sensors in each of the two sensitive areas do not detect the ambient light;
when all light sensors from a first sensitive area do not detect the ambient light, determining that a left hand of a user holds the portable touch control device; and
when all light sensors from a second sensitive area do not detect the ambient light, determining that a right hand of a user holds the portable touch control device.
